(19) United States
(12) Patent Application Publication
(10) Pub. No.: US 2013/0211174 A1
(43) Pub. Date: Aug. 15, 2013

(54) Gamma Radiation Apparatus for Remediation of Organic Compounds in Waste Slurries

(71) Applicants: Christopher Grant WEISENER, Windsor (CA); Jan Julian Hugh CIBOROWSKI, La Salle (CA)

(72) Inventors: Christopher Grant WEISENER, Windsor (CA); Jan Julian Hugh CIBOROWSKI, La Salle (CA)

(21) Appl. No.: 13/397,132

(22) Filed: Feb. 15, 2012

(51) Int. Cl. A62D 3/172; A62D 3/17; G21K 5/08

(52) U.S. Cl. 588/307; 250/435; 250/437; 588/306

(57) ABSTRACT

A process for the remediation and treatment of tar sands tailings, all process waters and waste slurries comprises irradiating the waste slurry with gamma radiation to degrade naphthenic acids in the waste slurry and reduce the potential of environmental harm caused by waste slurry discharge and accelerate to natural or assisted rehabilitation of this material into the natural environment.

### SCOPE OF THE INVENTION

The present invention relates to a system and method for the remediation of oil and/or oil sands waste slurries, tailings and process waters, and more particularly a system and process which uses electromagnetic radiation to facilitate the breakdown and/or degradation of naphthenic acids and other organic compounds found in petroleum production waste slurries, tailings and by-products that are toxic to life forms.

### BACKGROUND OF THE INVENTION

The oil sands deposits of Northeastern Alberta are one of the largest oil reserves in the world, containing an estimated 2.5 trillion barrels of recoverable bitumen held in a mineral matrix consisting of sand, clay and water. Traditional methods used to extract bitumen from excavated oil sands involve the Clark process (caustic hot water digestion and flotation), which produces a fine tailing slurry consisting of water, sand, fines (clay fraction <44-um particles), residual bitumen (0.5-5% by mass) and naphtha products (˜<0.5%) comprising a material known as fluid fine tails and oil sands process water.

Naphthenic acids, which are a general mixture of cyclopentyl and cyclohexyl acids having molecular weight between about 120 to in excess of 700; and which for example may have a general structure of formula (1):

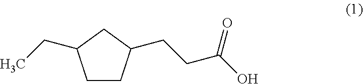

form a component of mostly petroleum production waste products, including those found in the processing and extraction of Athabasca oil sands. The main fraction of naphthenic acids are carboxylic acids of 9 to 20 carbon. The occurrence of naphthenic acids in the environment can pose significant problems since freshly released naphthenic acids are toxic to aquatic organisms. Although toxicity declines with time in the environment, the refractory components of the naphthenic acids in water mixtures can persist for many years. Concentrations of naphthenic acids in oil sands process water have been observed as high as 110 mg/L and generally above 60 ppm, although experimental ponds created with fluid fine tails and process water more typically tend to have concentrations in the 20-25 mg/L range.

Various remedial treatment options have been explored to promote and/or speed the degradation process of naphthenic acids and reduce the potential in situ effects of naphthenic acids on environmental systems. Conventional remedial processes range from chemical treatments to biological treatments using microbial enrichments and phytoremediation, bioremediation, and photo-catalysis treatments. Heretofore, however, conventional treatment methods have not proven commercially successful in treating high volume waste slurry streams.

### SUMMARY OF THE INVENTION

The applicant has appreciated that electromagnetic energy may advantageously be used in the remediation of a variety of different types of waste streams and/or slurries which result from petroleum production processes, including tar or oil sands waste slurries, fluid fine tails or tailings and/or process waters (hereinafter collectively referred to as waste slurries). In particular, the applicant has appreciated that by irradiating the waste slurry with electromagnetic radiation, and preferably gamma radiation, the degradation of various organic compounds and in particular naphthenic acids, in the waste slurry may be advantageously accelerated. The facilitation of the decomposition of naphthenic acids reduces the major toxin to life forms in these tailings and thus may thereby reduce the potential of environmental harm caused by waste slurry discharge and accelerate the rehabilitation of these tailing by natural environmental means.

Accordingly, one object of the invention is to provide a system for the continuous or batch treatment of waste slurries, and preferably oil sands process water and/or fluid fine tails by irradiation with electromagnetic energy, and preferably gamma radiation, to facilitate decomposition of organic compounds therein.

The applicant has appreciated that gamma radiation may be used successfully to breakdown naphthenic acids in the waste slurry as part of a batch or continuous flow process, whilst concurrently sterilizing sediments, reducing the naphthenic acid to levels that various life forms can tolerate, eliminating any biological components in materials without affecting the other elements of the soil geochemistry. Without being limited to a particular mode or theory it is believed that ionizing gamma radiation disrupts the cyclic chemical structure of various naphthenic acids congeners. Gamma irradiation thus has significant potential as means of naphthenic acid removal from not only waste slurries from petrochemical production processes, but also other waste streams, including mine tailings materials both prior to their release into the environment, as well as following release as part of remedial treatment operations.

In one embodiment, gamma irradiation may advantageously be used to accelerate degradation and/or increase the bioavailability potential of naphthenic acid containing waste slurries and waste water. Further, applicant's preliminary studies do not suggest the formation of persistent or potential toxic degradation products generated by the irradiation of waste slurries with gamma radiation. As such, in one preferred application, the present invention envisions remediation method by the use of gamma irradiation in breaking down naphthenic acid mixtures in oil sands process water and fluid fine tails concentrated by the bitumen extraction process from tar sands.

In another embodiment, the applicant has envisioned a system whereby a selected volume of a waste slurry is irradiated within a suitable reaction vessel with gamma radiation at an intensity level of between about 5 to 50 Gray per kilogram, ad preferably 12 Gray per kilogram (Gy/kg) to about 25 Gray per kilogram (Gy/kg) for a period of between about 0:1 minutes to 20 minutes, as part of a continuous flow or batch treatment process.

Larger or shorter treatment times may however be used depending on waste flow rates and volumes.

In one preferred application, slurry is provided to a reaction vessel in a substantially continuous flow rate of at least 2.5 l/min, preferably at least 20 l/min, and more preferably upto at least 50 l/min.

In the case of continuous treatment process, liquid waste slurry is pumped through the reaction vessel at a flow rate of about to achieve 12 to 25 Gy which will result in a reduction in naphthenic acid of roughly 96% bringing the naphthenic acid levels in the tailing to under 10% or 10 ppm, and more preferably less than 5 ppm.

More preferably, however, oil sands waste slurries are irradiated in a treatment system as part of a continuous-flow treatment process. In a simplified construction, the slurry is pumped directly from its production source through suitable in line continuous flow treatment chamber, then optionally on to any other treatment such as filtration, heating and/or settlement and then deposited for site rehabilitation as required. The vessel/chamber is provided with a suitable gamma radiation source which, for example, result in 12 to 25 Gy radiation of the tailing materials.

In select embodiments, cobalt-60, and electron beam generator, an ion beam generator or an x-ray accelerator are used as a source for gamma radiation.

More preferably, the gamma radiation source is provided with at least one and more preferably multiple electromagnetic energy emitters.

In a simplified construction, the reaction vessel may consist of a simple shielded pipe along which the waste slurry flows or is pumped, and where the radiation emitters are either mounted on or embedded into the pipe sidewall. In an alternate construction, the waste slurry may be pumped through the interior of a shielded reaction vessel or housing. In the interior of the reaction vessel, the slurry conduits may be provided with coiled, serpentine or other labyrinthine-like orientation to maximize waste slurry residence time with the reaction during irradiation treatment.

It is to be appreciated that the output intensity of the radiation used to treat each waste slurry will vary, depending on a variety of factors. These include the initial concentrations of naphthenic acid and/or other organic acids to be treated; whether the slurry volume to be treated is introduced into the reaction vessel as either a batch and/or as a continuous process; the pumping or flow rate of the slurry through the reaction vessel; and/or the intensity of the radiation emitted by the electromagnetic emitters. In a most preferred commercial application, the radiation source is operable to emit gamma radiation at an intensity of between about 12 Gy/kg to about 25 Gy/kg, and preferably resulting in a <10 ppm naphthenic acid more preferably <5 ppm naphthenic acid.

Accordingly, in one aspect the present invention resides in a system for reducing the concentration of organic acids, and most preferably naphthenic acid in a waste slurry, the system including: a housing for receiving a volume of slurry to be treated therein; a radiation source having at least one radiation emitter operable to irradiate said volume of slurry in the housing with electromagnetic radiation; and a conduit system including a conduit for delivering untreated slurry into said housing for irradiation therein, and for conveying irradiated slurry therefrom.

In another aspect, the present invention resides is a system for reducing the concentration of naphthenic acids in a waste slurry, the system including, a housing having an interior for receiving a volume of slurry to be treated therein, a radiation source having at least one radiation emitter operable to irradiate said volume of slurry in the housing interior with gamma radiation, at least one of a conveyor and a conduit for delivering said volume of slurry to said housing for irradiation.

In a further aspect, the present invention resides in a process for reducing the concentration of naphthenic acid in a petrochemical manufacturing process waste slurry, the process including: receiving a volume of untreated waste slurry in a reaction vessel; irradiate said volume of slurry in the reaction vessel with gamma radiation at an treated intensity level selected at between about 12 Gray per kilogram (Gy/kg) and 25 Gray per kilogram (Gy/kg), for a period of time selected to result in a <10 ppm naphthenic acid content in the conveying irradiated slurry conveyed from the reaction vessel.

### BRIEF DESCRIPTION OF THE DRAWINGS

Reference may now be had to the following detailed description taken together with accompanying drawings, in which:

FIG. 1 shows schematically a waste slurry treatment system in accordance with a first embodiment of the invention;

FIG. 2 shows a schematic partial view of a waste treatment system in accordance with a further embodiment of the invention; and

FIG. 3 shows a waste treatment system in accordance with another embodiment of the invention.

### DETAILED DESCRIPTION OF THE INVENTION

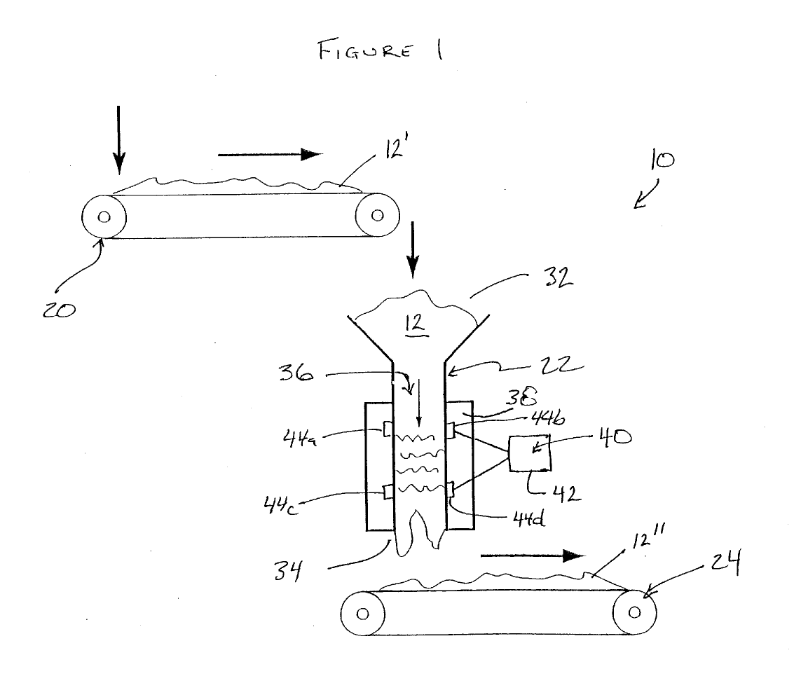

Reference may now be had to FIG. 1 which illustrates a slurry treatment system 10 in accordance with a first embodiment of the invention. In the embodiment shown, the treatment system 10 is provided for the remediation of a waste slurry which comprises a semi-solid oil sands waste tailings 12. As will be described the system 10 is operable to degrade and/or breakdown a tar naphthenic acid component of the tailings 12 to facilitate the waste slurry remediation to a more environmentally harmless waste by-product.

FIG. 1 shows the treatment system 10 as including an infeed conveyor 20, a reaction vessel 22, and an outfeed conveyor 24. The infeed conveyor 20 provides communication between a tailings supply, such as a tailings pond or dewatering plant (not shown) and the reaction vessel 22. The tailings pond provides a source of untreated waste slurry 12′ produced in the extraction and process of oil from tar sands. In operation, the conveyor 24 supplies untreated tailings 12′ to an inlet end 32 of the reaction vessel 22. The outfeed conveyor 24 provides communication between an outlet end 34 of the reaction vessel 22 and a treated tailings depository, setting pond or the like (not shown), where treated slurry 12″ is discharged for either additional processing and/or further remediation such as filtering; or alternatively where the slurry 12″ has been adequately pretreated, directly into the environment.

In a most simplified construction reaction vessel 22 is formed having an interior flow passage 36 which extends from the inlet end 32 to the outlet end 34, and which is defined by a surrounding shielding sidewall 38. Although not essential, the flow passage 36 preferably extends in a generally vertical orientation to allow the waste slurry 12 to move therethrough under the force of gravity. Optionally a screw drive, auger or a suitable impeller (not shown) may be provided within the flow passage 36 to facilitate and/or control the speed at which the tailings 12 move therethrough. The shielding sidewall 38 is preferably formed from a suitable shielding material, such as high density concrete, and which is selected to absorb and/or substantially prevent any transmission of gamma radiation therethrough. A gamma radiation energy generator 40 is provided in conjunction with the reaction vessel 22. The gamma radiation generator 40 includes a gamma radiation source 42 which may for example consist of cobalt-60 having a half life of about 5.27 years spent reactor control rods, and/or a suitable electromagnetic energy generator, such as an electron or ion beam generator, or an x-ray accelerator.

Although not essential, the generator 40 communicates with a number of gamma ray emitter heads 44a,44b,44c,44d which are radially disposed at longitudinally spaced locations along the sidewall 38. The emitter heads 44a-d are positioned operable to emit gamma rays produced in the generator 40 across the flow passage 36 where it extends through the sidewall 38. In this manner, the radiation source 42 may be activated to emit gamma radiation via the emitters 44a,44b,44c,44d through the waste slurry 12 as it flows continuously through the reaction vessel 22. Most preferably, the slurry 12 is moved at a flow rate through the flow passage 36 at a rate selected to ensure the irradiation of the slurry 12 with gamma radiation from the radiation source 42 at an intensity of between about 12 Gy/kg and 25 Gy/kg irradiation of the material.

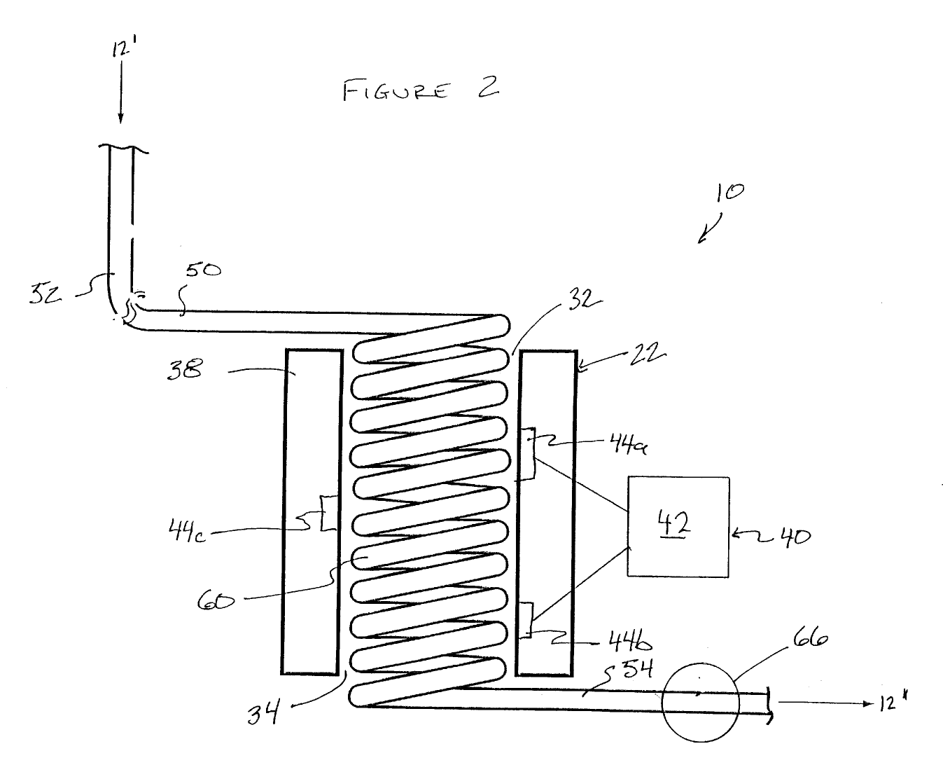

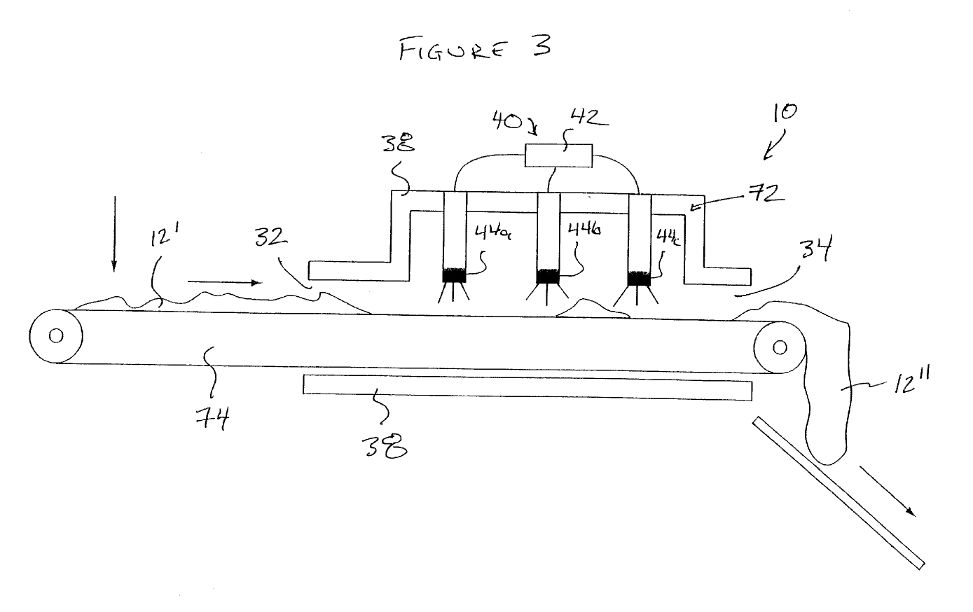

Although the embodiment of FIG. 1 illustrates the system 10 as including four emitter heads 44a,44b,44c,44d used to irradiate the waste slurry 12 as it travels through the reaction vessel 22, the invention is not so limited. Reference may be had to FIGS. 2 and 3 which, as will be described, illustrate alternate embodiments of the invention in different arrays of emitter heads 44a,44b,44c are arranged within a reaction vessel 22. Although the slurry treatment system 10 of FIG. 1 is described in the treatment of semi-sold tailings, the invention is not so limited. Reference may be made to FIG. 2 which shows a waste slurry treatment system 10 in accordance with a further embodiment, wherein like reference numerals are used to identify like components.

The system 10 of FIG. 2 is adapted for the processing and treatment of more liquefied waste slurries, and which for example include greater purportions by volume of oil sands process water. In the system of FIG. 2 a waste slurry infeed pipe 50 and a treated slurry outfeed pipe 54 are provided in place of the infeed and outfeed conveyors shown in FIG. 1.

In the embodiment shown, the infeed pipe 50 provides fluid connection between a tailings pond outlet 52 and the inlet end 32 of the reaction vessel 22. Optionally, a helically coiled conduit portion 60 is disposed along the interior of the reaction vessel 22. The coiled conduit portion 60 substantially contained within the shielded sidewall 38 and provides fluid communication with the outlet end 34 and between the reaction vessel and the slurry outfeed pipe 54. Although not essential, most preferably a pumping assembly 66 is fluidically coupled to the system 10 along the outfeed pipe 54. The conduit 60 is provided with a diameter selected having regard to the gamma radiation source to allow for the irradiation of the liquefied waste slurry at the desired intensity. The final pipe diameter will therefore be scalable with the type of radiation source.

Although not essential, as naphthenic acids are generally known to be corrosive, to maximize the lifespan of the system 10, the pumping assembly 66 is most preferably located within the system 10 downstream from the reaction vessel 22. With this configuration, the pumping assembly 66 advantageously draws as intake slurry 12″ which has been previously pretreated with gamma radiation within the reaction vessel 22 to reduce the overall naphthenic acid content of input liquid.

The pumping assembly 66 is configured so that when actuated, slurry is pumped through in a substantially continuous treatment process at a constant flow rate selected to achieve sufficient residence time of the slurry within the reaction chamber to reduce naphthenic acid levels therein to concentrations of less than about 25 ppm and preferably less than 10 ppm.

In operation of the system 10 of FIG. 2, the pumping assembly 66 is activated to draw untreated waste slurry 12′ from the tailings pond outlet 52 into and along the conduit coiled 60 via infeed pipe 50. Simultaneously the gamma radiation generator 40 is activated to emit gamma radiation via emitter heads 44a,44b,44c, thereby irradiating waste slurry as it moves through the helical coils of the conduit 60 within the interior reaction vessel 22. The applicant has appreciated that as the irradiation of the waste slurry occurs, this advantageously facilitates the breakdown and decomposition of naphthenic acids, rendering the treated waste slurry 12″ discharged from the effluent outfeed pipe 54 less environmentally harmful.

In use of the apparatus shown in FIG. 2, the pumping assembly 66 is activated to draw waste slurry 12 from the tailings pond outlet 52 along the conduit 60 and into the reaction vessel 22 as part of a continuous process. As the waste slurry 12 is pumped past along the shielded sidewall 38 segment, the gamma radiation generator 40 is activated to emit gamma radiation from the emitter heads 44a,44b,44c, to irradiate the waste slurry. Where multiple radiation emitter heads 44a,44b,44c are provided, most preferably the radiation source 42 is selected to emit gamma radiation with an intensity of 5 to 50 Gy/kg and preferably about 12 Gy/kg to about 25 Gy/kg and for a sufficient period of time to effect the desired degree of naphthenic acid degradation.

It is to be appreciated that in another configuration, the conduit 60 may be provided without any helical or coiled portions. Further, the conduit 60 itself could be formed itself as a shielded segment having a sidewall formed with increased radially thickness selected to substantially prevent the transmission of gamma radiation therethrough. In another embodiment, shown in FIG. 3, in which like reference numerals are used to identify like components, the reaction vessel 22 may be constructed to receive waste slurries 12 in a more solid form. The shielded sidewall 38 formed as a high density concrete reaction vessel 72 having a stainless steel inner sleeve lining. In the embodiment the gamma radiation generator 40 is provided with three longitudinally spaced emitter arrays 44a,44b,44c. As shown in FIG. 3, each array of emitter heads 44a,44b,44c, are positioned above a conveyor 74 which extends longitudinally through the reaction vessel interior. In an alternate constructions, the emitter heads 44a,44b,44c embedded directly into the shielded sidewall 38 and operable to irradiate the slurry 12 as it moves therepast on conveyor 74.

### Experimental Studies

To assess the suitability of gamma radiation in the remediation of waste slurry, experimental results were undertaken. Experimental protocols included:
1. Measuring concentrations and derivative breakdown products of naphthenic acid in natural and gamma irradiated oil sands process water and fluid fine tails matrices.
2. Conducting microbial and invertebrate bioassays to evaluate the initial and residual toxicity of gamma radiation-treated samples relative to non-irradiated samples.
3. Assessing biological (kinetic) responses of microbes inoculated into irradiated materials and their ability to further degrade naphthenic acids and reduce toxicity to other biota
4. Investigating the effects of irradiated fluid fine tails and oil sands process water on indigenous bacterial populations in situ; to provide insight on the potential efficacy of native biota and information on the biotransformation kinetics of treated materials. Phylogenetic analysis of the evolving microbial community was used to detect possible shifts in proteobacterial sequences related to well known aromatic degrading isolates.
5. Comparing and contrasting the effect of exposure to gamma irradiation on old and new fluid fine tail samples.
6. Examining the differences in the daughter products that are created through the irradiation of oil sands process water relative to those that are created naturally through the degradation of naphthenic acids in the settling ponds.

In preliminary studies comparative methods of distinguishing purely physicochemical processes on pore water chemistry and the volume and quality of the cap water from the effects of biogenic (microbial) metabolism were used to evaluate the stability and bioavailability of waste slurries contains fluid fine tails and oil sands process water during aging simulations for end pit lake studies on sediment dynamics. It was shown that in gamma irradiated samples, the naphthenic acids concentrations in the oil sands process water and fluid fine tails were reduced to as low as 5% of the concentrations in untreated samples. As such, studies suggest that gamma radiation may achieve upto 94.8% reduction in the group of organic naphthenic acids compounds in waste slurries.

Using representative oil sands process water and fluid fine tails samples supplied by Suncor™, as a first stage, laboratory experimental microcosms containing materials obtained from Suncor sites were analyzed for both irradiated and control samples. Measurements of processes going on within the microcosms provided information on the chemical, physical, and biological processes in the gamma treatments relative to control conditions.

Repeated-measures monitoring is used to quantify the influence of the gamma treatment on the volume and quality of naphthenic acids in the water cap. Changes seen in the fluid fine tails in the microcosms used to simulate the influence that might be expected if the last layer of material deposited in a settling basin were subjected to gamma irradiation. This layer is understood to likely have the greatest short-term influence on the quality of the water cap. The microcosms containing fluid fine tails will not have an established biofilm at the water tailings interface. Gamma-sterilized material may be inoculated with representative, non-sterilized aliquots of oil sands process water and fluid fine tails.

Anaerobic microcosms are used to study the effects of anoxic conditions on the degradation pathways used by anaerobic bacteria in the gamma treated samples. The volume and quality of the water cap will change as a function of the rate of pore water release from the tailings layer in the microcosms. The only gradients or transition zones would be at the water-tailings interface as constituents diffuse from the sediments into the overlying water.

Aerobic microcosms are used to study the effects of oxygen availability on the degradation pathways used by facultative aerobic bacteria in the gamma treated samples. A transitional biofilm may develop at the (anoxic) sediment-(oxygenated) water interface, and wherein epibenthic layer of water and the surface layer the water cap and headspace should remain anaerobic. This allows an oxygen concentration gradient to form, extending from the aerobic water surface to below the anaerobic sediment-water interface. The extent and steepness of this gradient may be monitored by direct measurements of oxygen, pH, redox potential and changes (Eh) using a microelectrode array. The thickness of the transition zone is determined by detecting changes in the Eh signatures of reactions that comprise the oxygen demand (net demand) and diffusion from the lower anaerobic layer through the fluid fine tails/oil sands process water interface (expressed water derived from consolidation). Continued degradation of the gamma irradiated naphthenic acid by-products may thus be verified by collecting water samples.

Concentration and toxicity of naphthenic acid and its degradation products were assessed through periodic chemical analyses performed with aliquots of capping water collected through the course of the study as shown in Table 1 below:

TABLE 1
COMPARISON-WATER CHEMISTRY PARAMETERS FOR
IRRADIATED AND NON-IRRADIATED OSPW SAMPLES

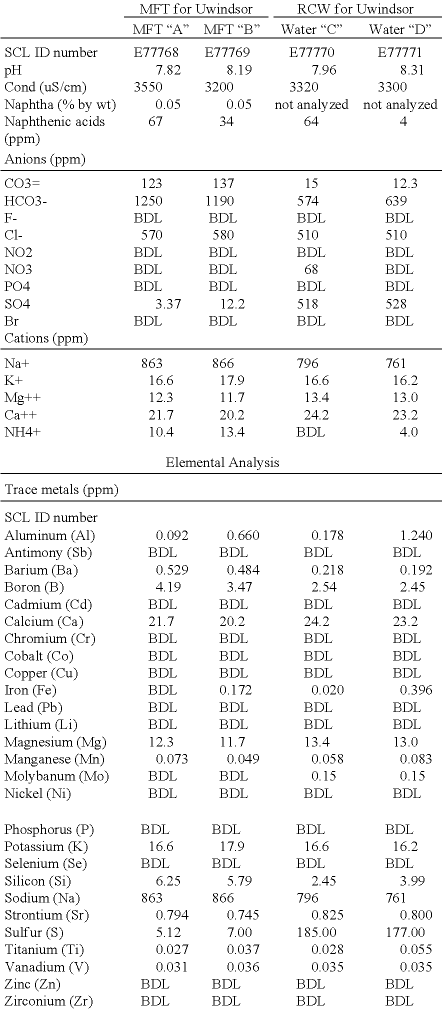

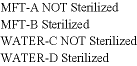

Water samples were submitted for chemical analysis using established protocols and labs. Selected bulk water samples (from matched control and treatment microcosms) were aerated and used to assess toxicity to aquatic invertebrates in standard (Ceriodaphnia dubia and 10-d Chironomus riparius) dilution bioassays.

The gamma-irradiated samples did not appear to exhibit the significant toxicity characteristic of the naphthenic acids of freshly produced oil sands process water, but that the half-life of toxicity will be much reduced relative to untreated oil sands process water owing to the effect of the ionizing radiation on the most stable chemical bonds.

Analytical methods developed for determining naphthenic acids concentrations in samples prior to and after treatment shows the efficacy of gamma irradiation in reducing the naphthenic acids concentrations. The presumptive composition of naphthenic acids (cyclopentane or cyclohexane with a carboxylic functional group) places these molecules in the same range as petroleum ethers (C4 to C8) or light gasoline (C8 to C10) compounds. Due to the difficulties in determining the abundances of individual naphthenic acids in samples, however, naphthenic acid concentrations were determined a gross characterization or ‘screening’ technique similar to but modified from methods used to determine gasoline-range total petroleum hydrocarbons (e.g., U.S. EPA Method 8015 series). Determination of derivatives was accomplished using GC/MS techniques at the University of Carlton.

Although the detailed description describes the operation of the invention in the remediation and treatment of oil sands waste slurries, the invention is not so limited. It is to be appreciated that the present invention may be used in the treatment of a variety of waste slurries generated in petrochemical and/or chemical production process, and where the degradation of organic acids, including, without restriction, other naphthenic or carboxylic acids may be desirable.

While the preferred embodiment of the invention describes the gamma radiation energy generator 40, as generating gamma rays, the invention is not so limited. It is to be appreciated that other types of electromagnetic radiation may be generated and/or used in conjunction with generated gamma rays to facilitate the breakdown of not only naphthenic acid, but other organic acids or compounds present in the waste slurry.

Although the detailed description describes and illustrates various preferred embodiments, the invention is not so limited. Many modifications and variations will now occur to persons skilled in the art. For a definition of the invention, reference may be had to the appended claims.

We claim:

1. A system for reducing the concentration of organic acids in a waste slurry, the system including:
a housing for receiving a volume of slurry to be treated therein;
a radiation source having at least one radiation emitter operable to irradiate said volume of slurry in the housing with electromagnetic radiation; and
a conduit system including a conduit for delivering untreated slurry into said housing for irradiation therein, and for conveying irradiated slurry therefrom.

2. The system of claim 1, wherein said conduit is operable to deliver untreated slurry into said housing as a substantially continuous flow at a rate of upto 50 l/min

3. The system of claim 1, wherein said electromagnetic energy comprises gamma radiation at an emitted intensity level sufficient to provide between about 12 Gray per kilogram (Gy/kg) and 25 Gray per kilogram (GY/kg), exposure.

4. The system of claim 3, wherein said conduit includes a coiled and/or sinuously extending portion disposed in said housing, the housing further including shielding for substantially preventing the release of emitted gamma radiation therefrom.

5. The system of claim 4, wherein said waste slurry comprises an oil sands waste slurry and said organic acids comprise naphthenic acids.

6. The system of claim 5, wherein said radiation source includes a plurality of said radiation emitters disposed at spaced locations about said coiled and/sinuously extending portion.

7. A system for reducing the concentration of naphthenic acids in a waste slurry, the system including,
a housing having an interior for receiving a volume of slurry to be treated therein,
a radiation source having at least one radiation emitter operable to irradiate said volume of slurry in the housing interior with gamma radiation,
at least one of a conveyor and a conduit for delivering said volume of slurry to said housing for irradiation.

8. The system as claimed in claim 7, wherein said waste slurry comprises a fluid slurry, said conduit including at least one of a coiled and a sinuously extending portion disposed in said housing interior, and a slurry supply for supplying said volume of said waste slurry to said housing interior as part of a substantially continuous treatment process.

9. The system as claimed in claim 8, wherein said conduit is for delivery of said volume of waste slurry through the interior of said housing at a flow rate selected whereby the volume to be treated is exposed to said gamma radiation at a radiation dosage of between about 12 Gray per kilogram 12 Gy/kg to 25 Gray per kilogram 25 Gy/kg.

10. The system as claimed in claim 8, wherein said conduct includes a portion extending in the housing interior, the radiation source includes a plurality of said radiation emitters at generally equally spaced locations about the portion of said conduit.

11. The system as claimed in claim 7, wherein the wherein said radiation source is operable to output said gamma radiation at a intensity level that is able to deliver 12 Gray per kilogram (Gy/kg) and about 25 Gray per kilogram (Gy/kg) radiation exposure to the volume to be treated.

12. The system as claimed in claim 11, wherein said volume of slurry to be treated contains said naphthenic acids in a concentration of selected at between about 25 to 500 ppm, and preferably about 75 ppm.

13. The system as claimed in claim 7, wherein the waste slurry is selected from an oil sands tailing slurry and an oil sands process water.

14. The system as claimed in claim 13, wherein the conduit is operable to deliver said volume of waste slurry as part of a batch process.

15. Use of the apparatus of claim 1 for reducing a concentration of naphthenic acids in a waste slurry comprising, activating said radiation source to irradiate an input volume of said slurry with said electromagnetic radiation.

16. The use as claimed in claim 15, wherein said waste slurry comprises at least one of oil sands tailings and an oil slurry sands process water and electromagnetic comprises gamma radiation.

17. Use as claimed in claim 16, comprising emitting said radiation from said radiation source to expose said volume of slurry to gamma radiation at an intensity of between about 5 Gy/kg and about 50 Gy/kg.

18. Use as claimed in claim 17 further comprises delivering of said volume of slurry to said housing at a flow rate selected such that exposure to said gamma radiation reduces said concentration of naphthenic acid in said volume of slurry to an amount less than about 10 ppm.

19. Use as claimed in claim 18, wherein prior to exposure to said gamma radiation, said volume of slurry to be treated comprises naphthenic acids in a concentration selected at between about 25 mg/l about 250 mg/l.

20. Use as claimed in claim 19, wherein said slurry is irradiated with said gamma radiation for a period selected to achieve exposure of said volume of slurry to said gamma radiation at 12 Gy/kg to about 25 Gy/kg exposure.

21. A process for reducing the concentration of naphthenic acid in a petrochemical manufacturing process waste slurry, the process including:
receiving a volume of untreated waste slurry in a reaction vessel;
irradiate said volume of slurry in the reaction vessel with gamma radiation at an emitted intensity level selected to achieve between about 12 Gray per kilogram (Gy/kg) and 25 Gray per kilogram (Gy/kg), exposure
conveying irradiated slurry from the reaction vessel.

22. The process of claim 21, wherein said waste slurry is provided to said reaction vessel as a substantially continuous flow.

23. The process of claim 21, wherein the untreated waste slurry comprising at least one of tar sands fluid fine tailings and oils sands process water containing naphthenic acids in an amount upto 110 mg/l.
